(19) United States
(12) Patent Application Publication
(10) Pub. No.: US 2012/0157141 A1
(43) Pub. Date: Jun. 21, 2012

(54) CONTENTION BASED UPLINK TRANSMISSION METHOD

(75) Inventors: Soon Yong LIM, Daejeon (KR); Mi Jeong YANG, Daejeon (KR); Ae Soon PARK, Daejeon (KR)

(73) Assignee: Electronics and Telecommunications Research Institute, Daejeon (KR)

(21) Appl. No.: 13/332,733

(22) Filed: Dec. 21, 2011

(30) Foreign Application Priority Data
Dec. 21, 2010 (KR) 10-2010-0131432

(51) Int. Cl. H04W 72/04

(52) U.S. Cl. 455/509

(57) ABSTRACT

Provided is a contention based uplink transmission method. A base station may assign a contention based radio network temporary identifier (CB-RNTI) to a plurality of terminals, and terminals assigned with the same CB-RNTI may perform contention uplink transmission using the same radio resource.

### CROSS-REFERENCE TO RELATED APPLICATION

This application claims the priority benefit of Korean Patent Application No. 10-2010-0131432, filed on Dec. 21, 2010, in the Korean Intellectual Property Office, the disclosure of which is incorporated herein by reference.

### BACKGROUND

1. Field of the Invention

Embodiments of the present invention relate to a mobile communication system, and more particularly, to a terminal and a base station that may perform contention based uplink transmission.

2. Description of the Related Art

A contention based uplink transmission method may correspond to a transmission method of assigning the same uplink transmission resource to a plurality of terminals and enabling each of the terminals to transmit data to a base station using the same uplink transmission resource.

When an amount of data to be transmitted by each terminal is small, an uplink transmission resource may not be used for most of a time duration. Accordingly, even though each terminal occupies the uplink transmission resource every time data to be transmitted to the base station using an uplink occurs, a data collision probability may be low.

However, when an amount of data to be transmitted by each terminal is great, an amount of time in which each terminal occupies the uplink transmission resource may increase. Accordingly, a data collision probability may be high.

Accordingly, provided is a mobile communication system that may perform contention based uplink transmission.

### SUMMARY

An aspect of the present invention provides a mobile communication system that may perform a contention based uplink transmission.

Another aspect of the present invention also provides a method that may switch from a transmission method using a contention based radio network temporary identifier (CB-RNTI) to a transmission method using a cell radio network temporary identifier (C-RNTI).

According to an aspect of the present invention, there is provided an uplink data transmission method, including: setting a radio bearer; controlling the radio bearer to correspond to a CB-RNTI; receiving uplink transmission information from a base station; and transmitting data to the base station using the radio bearer corresponding to the CB-RNTI when the uplink transmission information includes the CB-RNTI.

The uplink data transmission method may further include receiving an instruction to correspond to the CB-RNTI from the base station. The controlling may include controlling the radio bearer to correspond to the CB-RNTI in response to the instruction.

The uplink transmission information may include information associated with an uplink radio resource, and the transmitting may include transmitting the data using the uplink radio resource.

The uplink transmission information may include information associated with a modulation scheme and a channel coding scheme with respect to the data, and the transmitting may include transmitting the data according to the modulation scheme and the channel coding scheme.

The uplink data transmission method may further include transmitting the data to the base station using a second radio bearer corresponding to a cell radio network temporary identifier (C-RNTI) when the uplink transmission information includes the C-RNTI.

The uplink data transmission method may further include receiving, from the base station, an invalidation signal with respect to the CB-RNTI; and switching the radio bearer to correspond to a C-RNTI in response to the invalidation signal.

When the uplink transmission information includes the C-RNTI, the transmitting may include transmitting the data using the switched radio bearer.

According to another aspect of the present invention, there is provided a terminal that is assigned with a CB-RNTI from a base station, the terminal including: a bearer setting unit to set a radio bearer; a controller to control at least one uplink buffer to correspond to the radio bearer; a receiver to receive uplink transmission information from the base station; and a transmitter to transmit, to the base station, data stored in the at least one uplink buffer, when the uplink transmission information includes the assigned CB-RNTI.

The receiver may receive an invalidation signal with respect to the CB-RNTI from the base station, the controller may switch the radio bearer to correspond to a C-RNTI in response to the invalidation signal, and the transmitter may transmit the stored data to the base station using the switched radio bearer.

When the uplink transmission information includes the C-RNTI, the transmitter may transmit the data to the base station using a second radio bearer corresponding to the C-RNTI.

According to still another aspect of the present invention, there is provided an uplink data receiving method, including: assigning a CB-RNTI to a first terminal and a second terminal; transmitting uplink transmission information including the CB-RNTI to the first terminal and the second terminal; and receiving data using the CB-RNTI from the first terminal or the second terminal in response to the uplink transmission information.

The uplink data receiving method may further include: assigning a C-RNTI to the first terminal; transmitting an invalidation signal with respect to the CB-RNTI to the first terminal; and receiving second data using the C-RNTI assigned to the first terminal.

The uplink transmission information may include information associated with an uplink radio resource, and the receiving may include receiving the data using the uplink radio resource.

The uplink transmission information may include information associated with a modulation scheme and a channel coding scheme with respect to the data, and the receiving may include receiving the data according to the modulation scheme and the channel coding scheme.

### SUMMARY

According to embodiments of the present invention, there may be provided a mobile communication system that may perform a contention based uplink transmission.

According to embodiments of the present invention, there may be provided a method that may switch from a transmission method using a contention based radio network temporary identifier (CB-RNTI) to a transmission method using a cell radio network temporary identifier (C-RNTI).

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a method of transmitting data using a contention based radio network temporary identifier (CB-RNTI) according to an embodiment of the present invention;

FIG. 2 is a diagram to describe an operation of a terminal to transmit data by controlling a radio bearer to correspond to a CB-RNTI according to an embodiment of the present invention;

FIG. 3 is a diagram to describe an operation of a terminal to transmit data by controlling a radio bearer corresponding to a CB-RNTI to correspond to a cell radio network temporary identifier (C-RNTI) according to an embodiment of the present invention;

FIG. 4 is a flowchart illustrating an uplink data transmission method according to an embodiment of the present invention;

FIG. 5 is a flowchart illustrating a process of controlling a radio bearer corresponding to a CB-RNTI to correspond to a C-RNTI according to an embodiment of the present invention;

FIG. 6 is a block diagram illustrating a structure of a terminal according to an embodiment of the present invention; and

FIG. 7 is a flowchart illustrating an uplink data receiving method according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

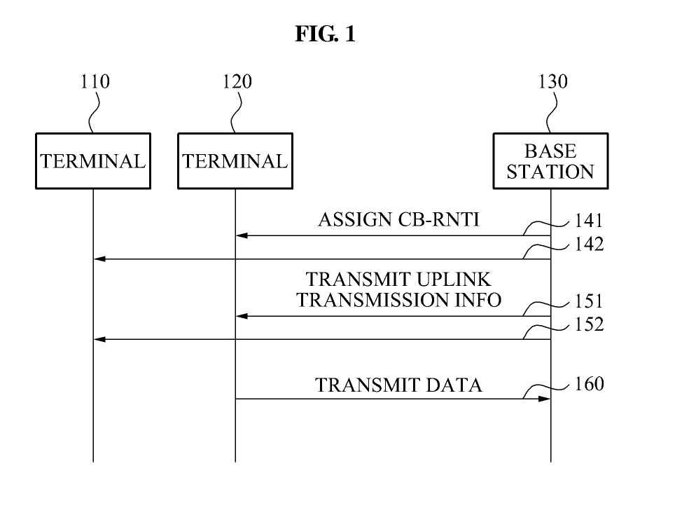

FIG. 1 is a diagram illustrating a method of transmitting data using a contention based radio network temporary identifier (CB-RNTI) according to an embodiment of the present invention.

A contention-free scheme may be employed for a terminal to transmit data to a base station. In a contention-free data transmission method, the base station may assign, to the terminal, a dedicated radio resource available by the terminal. The terminal may transmit data to the base station using the assigned dedicated radio resource. Since the terminal does not share a radio resource with other terminals, the terminal may stably transmit data to the base station.

A contention based data transmission method is a data transmission method of assigning the same radio resource to a plurality of terminals to share the assigned radio resource. When there is data to be transmitted to a base station, each terminal may transmit data using the assigned radio resource. On the contrary, when there is no data to be transmitted to the base station, the terminals may not occupy the assigned radio resource. When all of the terminals occupy the radio resource, none of the terminals may transmit data and a data collision may occur. Accordingly, the number of terminals that share the same radio resource may be restricted.

Referring to FIG. 1, in operations 141 and 142, a base station 130 may assign a contention based ratio network temporary identifier (CB-RNTI) to terminals 110 and 120. The CB-RNTI may be an identifier for identifying terminals that share the same radio resource among a plurality of terminals connected to the base station 130. The base station 130 may assign the CB-RNTI to each of the terminals 110 and 120 using a broadcasting channel or radio resource control (RRC) signaling.

In operations 151 and 152, the base station 130 may transmit uplink transmission information to the terminals 110 and 120. The uplink transmission information may include a CB-RNTI. Each of the terminals 110 and 120 may receive uplink transmission information and compare the CB-RNTI included in the uplink transmission information with the assigned CB-RNTI. When the CB-RNTI included in the uplink transmission information is identical to the assigned CB-RNTI, a corresponding terminal may transmit data to the base station 130 using the uplink transmission information.

The uplink transmission information may include information associated with an uplink radio resource used for each of the terminals 110 and 120 to transmit data to the base station 130.

When each of the terminals 110 and 120 includes data to be transmitted to the base station 130, each of the terminals 110 and 120 may transmit data to the base station 130 by referring to information associated with the uplink radio resource. Even though only the terminal 120 includes data to be transmitted to the base station 130 in the embodiment of FIG. 1, both the terminals 110 and 120 may include data to be transmitted to the base station 130 depending on embodiments. In this case, the terminals 110 and 120 may transmit data to the base station 130 using the assigned radio resource and thus, a data collision may occur.

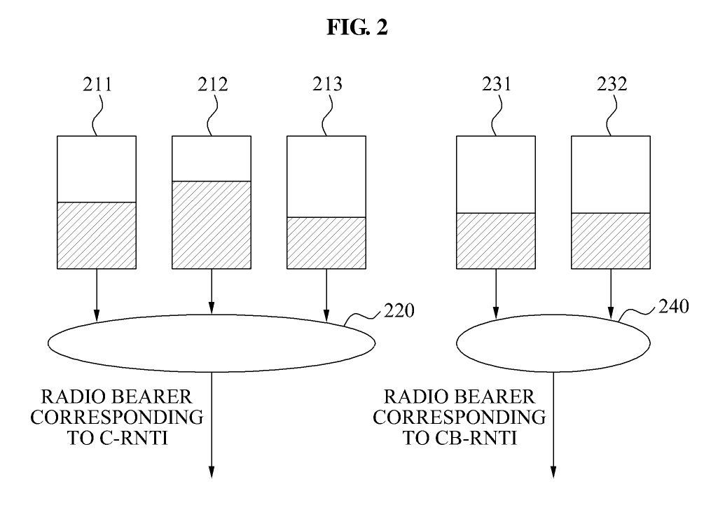

FIG. 2 is a diagram to describe an operation of a terminal to transmit data by controlling a radio bearer to correspond to a CB-RNTI according to an embodiment of the present invention.

The terminal may set a radio bearer to transmit data to a base station. Whether the terminal transmits data to the base station by controlling the set radio bearer to correspond to a cell radio network temporary bearer (C-RNTI), or by controlling the set radio bearer to correspond to a CB-RNTI may be determined according to control of the base station.

In FIG. 2, uplink buffers 211, 212, and 213 may correspond to a radio bearer 220, and uplink buffers 231 and 232 may correspond to a radio bearer 240. In each of the uplink buffers 211, 212, 213, 231, and 232, a shaded portion may express a portion where data is present. As described above, the uplink buffers 211, 212, and 213 may correspond to the radio bearer 220, and the uplink buffers 231 and 232 may correspond to the radio bearer 240. The radio bearer 220 may correspond to a C-RNTI and the radio bearer 240 may correspond to a CB-RNTI.

When uplink transmission information received by the terminal includes the CB-RNTI, the terminal may transmit data stored in the uplink buffers 231 and 232, using the radio bearer 240 corresponding to the CB-RNTI. Also, when the received uplink transmission information includes the C-RNTI, the terminal may transmit data stored in the uplink buffers 211, 212, and 213, using the radio bearer 220 corresponding to the C-RNTI.

Referring to FIG. 2, the terminal includes both the radio bearer 220 corresponding to the C-RNTI and the radio bearer 240 corresponding to the CB-RNTI, and may selectively transmit data based on an identifier included in the uplink transmission information.

According to the present embodiment, when there is no data stored in the uplink buffers 231 and 232 corresponding to the CB-RNTI, the terminal may not transmit data using the uplink. Accordingly, as compared to a case of employing only the C-RNTI, contention may decrease.

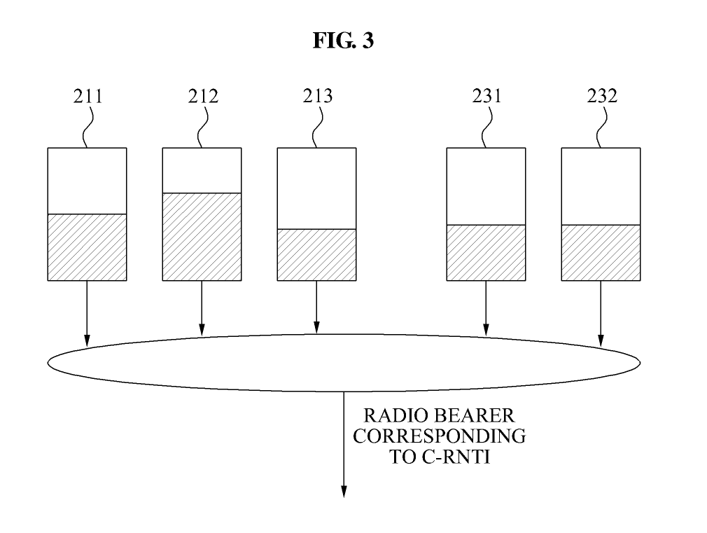

FIG. 3 is a diagram to describe an operation of a terminal to transmit data by controlling a radio bearer corresponding to a CB-RNTI to correspond to a C-RNTI according to an embodiment of the present invention.

When operating a base station, there may be a need to invalidate an existing assigned CB-RNTI. In this case, the base station may invalidate a CB-RNTI assigned to each terminal by transmitting a predetermined control signal. The terminal may delete the radio bearer 240 corresponding to the CB-RNTI, and may control the uplink buffers 231 and 232 corresponding to the deleted radio bearer 240 to correspond to the radio bearer 220 corresponding to the C-RNTI.

When the base station includes the C-RNTI in the uplink transmission information and thereby transmits the uplink transmission information, the terminal may transmit, to the base station, data that is stored in the uplink buffers 211, 212, 213, 231, and 232. The terminal may flexibly perform a generation, a correspondence, and a deletion of a radio bearer based on a necessity of the base station, link traffic, and the like.

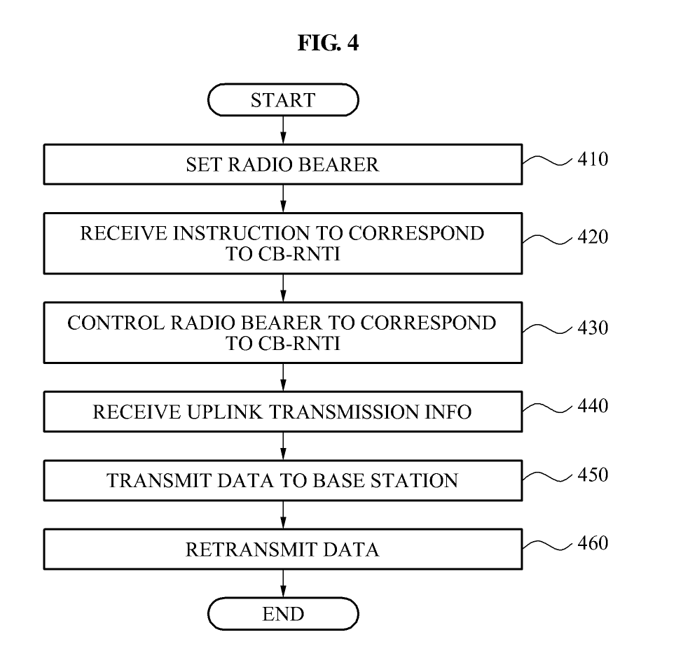

FIG. 4 is a flowchart illustrating an uplink data transmission method according to an embodiment of the present invention.

In operation 410, a terminal may set a radio bearer.

In operation 430, the terminal may control the radio bearer to correspond to a CB-RNTI. The terminal may receive an instruction to correspond to the CB-RNTI from a base station in operation 420. In operation 430, in response to the instruction, the terminal may control the radio bearer to correspond to the CB-RNTI.

In operation 440, the terminal may receive uplink transmission information from the base station. The uplink transmission information may include a CB-RNTI.

When the CB-RNTI included in the uplink transmission information is identical to the CB-RNTI assigned to the terminal, the terminal may transmit data to the base station using the radio bearer corresponding to the CB-RNTI in operation 450.

According to an aspect, the terminal may transmit, to the base station, data that is stored in an uplink buffer. The uplink buffer storing the data may be an uplink buffer corresponding to the radio bearer that corresponds to the CB-RNTI.

According to an aspect, the uplink transmission information may include information associated with an uplink radio resource. In this case, the terminal may transmit data using the uplink radio resource in operation 450. The uplink radio resource may indicate a predetermined frequency band or a predetermined time interval that is used for the terminal to transmit data to the base station.

According to an aspect, the uplink transmission information may include information associated with a modulation scheme or a channel coding scheme with respect to the data. In this case, in operation 450, the terminal may modulate data according to the modulation scheme included in the uplink transmission information, or may perform channel coding of the data according to the channel coding scheme included in the uplink transmission information.

According to an aspect, the same CB-RNTI may be assigned to a plurality of terminals. In this case, the plurality of terminals may receive the same CB-RNTI included in uplink transmission information. The terminals may share an uplink radio resource and may compete to transmit data to the base station using a contention based uplink transmission method.

For example, a first terminal and a second terminal may transmit data to the base station using an uplink radio resource included in uplink transmission information. The uplink transmission information may include information associated with a plurality of uplink radio resources. When the first terminal and the second terminal select different uplink radio resources, the first terminal may transmit first data to the base station using a first uplink radio resource and the second terminal may transmit second data to the base station using a second uplink radio resource. That is, a data occlusion may not occur and the first data and the second data may be transmitted to the base station without collision.

On the contrary, when the first terminal and the second terminal select the same uplink radio resource, the first data and the second data may collide with each other and thereby not be transmitted to the base station.

The terminal may transmit data using a C-RNTI as well as the CB-RNTI. In this case, the terminal may include a radio bearer corresponding to the C-RNTI as well as a radio bearer corresponding to the CB-RNTI.

When the uplink transmission information received in operation 440 includes the C-RNTI, the terminal may transmit data to the base station using the radio bearer corresponding to the C-RNTI.

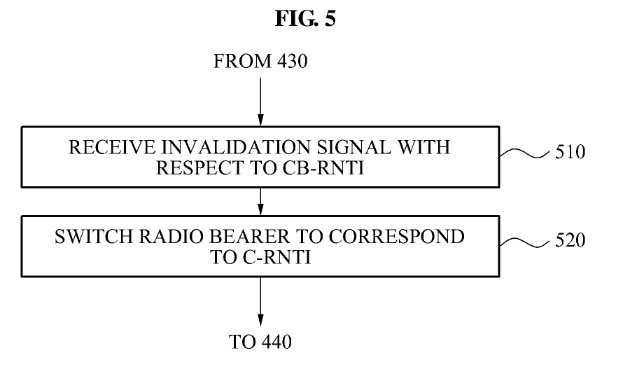

The terminal may invalidate the CB-RNTI. When the CB-RNTI is invalidated, the terminal may retransmit data to the base station using the radio bearer corresponding to the C-RNTI in operation 460. Hereinafter, a method of invalidating the preset CB-RNTI will be further described with reference to FIG. 5.

FIG. 5 is a flowchart illustrating a process of controlling a radio bearer corresponding to a CB-RNTI to correspond to a C-RNTI according to an embodiment of the present invention. The process of FIG. 5 may be performed between operations 430 and 440 of FIG. 4.

In operation 510, the terminal may receive an invalidation signal with respect to the CB-RNTI from the base station. In response to the invalidation signal, the terminal may invalidate the assigned CB-RNTI.

In operation 520, in response to the received invalidation signal, the terminal may switch the radio bearer corresponding to the CB-RNTI to correspond to the C-RNTI.

When the uplink transmission information includes the C-RNTI in operation 440, the terminal may transmit data using the switched radio bearer in operation 450.

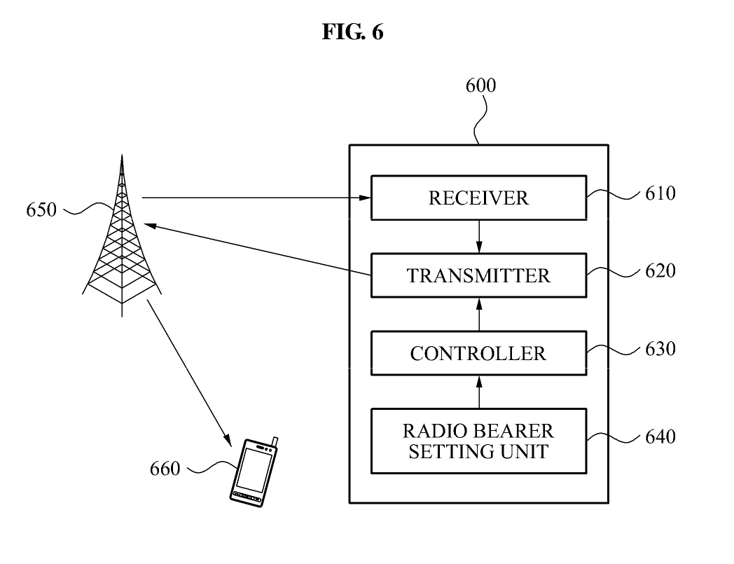

FIG. 6 is a block diagram illustrating a structure of a terminal 600 according to an embodiment of the present invention.

Referring to FIG. 6, the terminal 600 may include a receiver 610, a transmitter 620, a controller 630, and a radio bearer setting unit 640.

The terminal 600 may be assigned with a CB-RNTI from a base station 650.

The radio bearer setting unit 640 may set a radio bearer for transmitting data to the base station 650. The receiver 610 may receive, from the base station 650, an instruction to correspond to the CB-RNTI. In response to the instruction, the radio bearer setting unit 640 may control the radio bearer to correspond to the CB-RNTI.

The controller 630 may control at least one uplink buffer to correspond to the radio bearer. The terminal 600 may include a plurality of uplink buffers. The terminal 600 may control a portion of the uplink buffers to correspond to the radio bearer corresponding to the CB-RNTI, and control another portion of the uplink buffers to correspond to a radio bearer corresponding to a C-RNTI.

The receiver 610 may receive uplink transmission information from the base station 650. The uplink transmission information may include a CB-RNTI. The receiver 610 may compare the CB-RNTI assigned to the terminal 600 with the CB-RNTI included in the uplink transmission information.

When the assigned CB-RNTI is identical to the CB-RNTI included in the uplink transmission information, the transmitter 620 may transmit, to the base station 650, data stored in the uplink buffer using the radio bearer corresponding to the CB-RNTI.

According to an aspect, uplink transmission information may include information associated with a radio resource used for the terminal 600 to transmit data to the base station 650. The transmitter 650 may transmit data to the base station 650 by referring to information associated with the radio resource.

According to an aspect, the terminal 600 may be assigned with a C-RNTI as well as a CB-RNTI. When uplink transmission information received by the receiver includes a C-RNTI, the receiver 610 may compare the C-RNTI assigned to the terminal 600 with the C-RNTI included in the uplink transmission information. When the assigned C-RNTI is identical to the C-RNTI included in the uplink transmission information, the transmitter 620 may transmit, to the base station 650, data stored in the uplink buffer using a radio bearer corresponding to the C-RNTI.

According to an aspect, the base station 650 may assign a CB-RNTI to the terminal 600 and a terminal 660. In this case, the terminal 600 may transmit first data to the base station 650 by referring to information associated with a radio resource that is included in uplink transmission information. The terminal 660 may transmit second data to the base station 650 by referring to information associated with the radio resource that is included in the uplink transmission information. Since the terminals 600 and 660 transmit data using the same radio resource, a data collision may occur whereby a data transmission may fail.

According to an aspect, the base station 650 may invalidate a CB-RNTI that is assigned to each of the terminals 600 and 660. In this case, the receiver 610 may receive an invalidation signal with respect to the CB-RNTI from the base station 650. The controller 630 may switch a radio bearer corresponding to the CB-RNTI to correspond to a C-RNTI.

When uplink transmission information received by the receiver 610 includes the C-RNTI, the transmitter 620 may transmit, to the base station 650, data stored in the uplink buffer using the switched radio bearer.

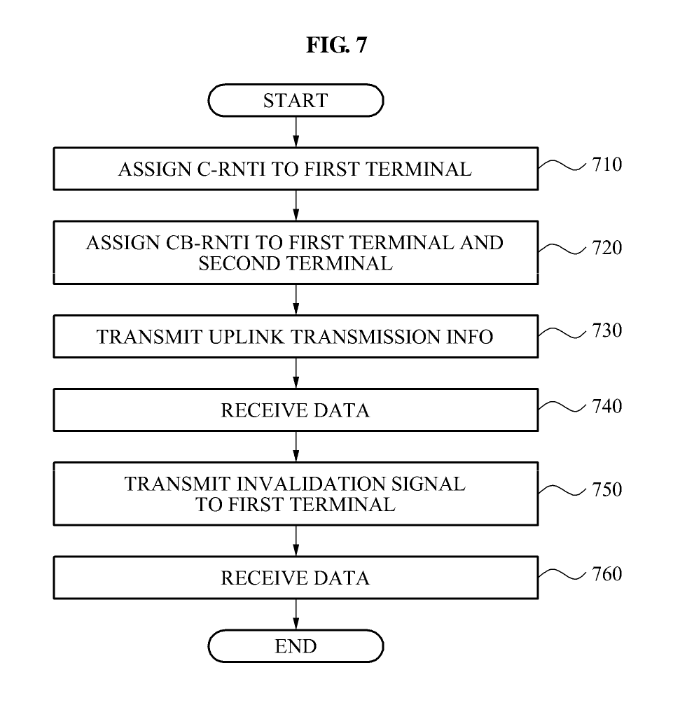

FIG. 7 is a flowchart illustrating an uplink data receiving method according to an embodiment of the present invention.

In operation 710, a base station may assign a C-RNTI to a first terminal. The C-RNTI may be an identifier that is used to identify a predetermined terminal within a cell and thus, a unique C-RNTI may be assigned to each terminal.

In operation 720, the base station may assign a CB-RNTI to the first terminal and a second terminal. The CB-RNTI may be assigned to a plurality of terminals. Terminals assigned with the same CB-RNTI may share an uplink radio resource and perform a contention based uplink transmission. The contention based uplink transmission is described above with reference to FIG. 1 and thus, further detailed description will be omitted here.

In operation 730, the base station may transmit uplink transmission information to the first terminal and the second terminal. The uplink transmission information may include the CB-RNTI.

In operation 740, the base station may receive data from the first terminal or the second terminal using the CB-RNTI. That is, when the CB-RNTI assigned to each terminal is identical to the CB-RNTI included in the uplink transmission information, each terminal may determine whether an uplink buffer stores data to be transmitted to the base station. When the uplink buffer stores data to be transmitted to the base station, each terminal may transmit data to the base station.

According to an aspect, uplink transmission information may include information associated with an uplink radio resource. In operation 740, the base station may receive data from the terminal using the uplink radio resource. The uplink transmission information may include information associated with a modulation scheme or a channel coding scheme with respect to the data. In operation 740, the base station may receive data that is modulated according to the modulation scheme, or may receive data that is channel coded according to the channel coding scheme.

According to an aspect, first data to be transmitted to the base station may be stored in an uplink buffer of the first terminal, and second data to be transmitted to the base station may be stored in an uplink buffer of the second terminal. In this case, the first terminal and the second terminal may respectively transmit the first data and the second data using the same uplink radio resource. When a plurality of terminals attempts to transmit data using the same radio resource, a data collision may occur whereby a data transmission may fail.

Depending on a necessity, the base station may invalidate the CB-RNTI assigned to each terminal. For the above operation, in operation 750, the base station may transmit an invalidation signal with respect to the CB-RNTI to the first terminal. In response to the invalidation signal, the first terminal may delete the CB-RNTI. The first terminal may switch a radio bearer corresponding to the CB-RNTI to correspond to the C-RNTI.

In operation 760, the base station may transmit, to the first terminal, uplink transmission information that includes the C-RNTI. In this case, the base station may receive data using the C-RNTI assigned to the first terminal. The data received by the base station in operation 760 may be data stored in an uplink buffer corresponding to the radio bearer that corresponds to the CB-RNTI.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An uplink data transmission method, comprising
setting a radio bearer;
controlling the radio bearer to correspond to a contention based radio network temporary identifier (CB-RNTI);
receiving uplink transmission information from a base station; and
transmitting data to the base station using the radio bearer corresponding to the CB-RNTI when the uplink transmission information includes the CB-RNTI.

2. The method of claim 1, further comprising:
receiving an instruction to correspond to the CB-RNTI from the base station,
wherein the controlling comprises controlling the radio bearer to correspond to the CB-RNTI in response to the instruction.

3. The method of claim 1, wherein the uplink transmission information comprises information associated with an uplink radio resource, and the transmitting comprises transmitting the data using the uplink radio resource.

4. The method of claim 1, wherein the uplink transmission information comprises information associated with a modulation scheme and a channel coding scheme with respect to the data, and the transmitting comprises transmitting the data according to the modulation scheme and the channel coding scheme.

5. The method of claim 1, further comprising:
transmitting the data to the base station using a second radio bearer corresponding to a cell radio network temporary identifier (C-RNTI) when the uplink transmission information includes the C-RNTI.

6. The method of claim 1, further comprising:
receiving, from the base station, an invalidation signal with respect to the CB-RNTI; and
switching the radio bearer to correspond to a C-RNTI in response to the invalidation signal.

7. The method of claim 6, wherein when the uplink transmission information includes the C-RNTI, the transmitting comprises transmitting the data using the switched radio bearer.

8. A terminal that is assigned with a contention based radio network temporary identifier (CB-RNTI) from a base station, the terminal comprising:
a bearer setting unit to set a radio bearer;
a controller to control at least one uplink buffer to correspond to the radio bearer;
a receiver to receive uplink transmission information from the base station; and
a transmitter to transmit, to the base station, data stored in the at least one uplink buffer, when the uplink transmission information includes the assigned CB-RNTI.

9. The terminal of claim 8, wherein:
the receiver receives an invalidation signal with respect to the CB-RNTI from the base station,
the controller switches the radio bearer to correspond to a cell radio network temporary identifier (C-RNTI) in response to the invalidation signal, and
the transmitter transmits the stored data to the base station using the switched radio bearer.

10. The terminal of claim 8, wherein when the uplink transmission information includes the C-RNTI, the transmitter transmits the data to the base station using a second radio bearer corresponding to the C-RNTI.

11. An uplink data receiving method, comprising:
assigning a contention based radio network temporary identifier (CB-RNTI) to a first terminal and a second terminal;
transmitting uplink transmission information including the CB-RNTI to the first terminal and the second terminal; and
receiving data using the CB-RNTI from the first terminal or the second terminal in response to the uplink transmission information.

12. The method of claim 11, further comprising:
assigning a cell radio network temporary identifier (C-RNTI) to the first terminal;
transmitting an invalidation signal with respect to the CB-RNTI to the first terminal; and
receiving second data using the C-RNTI assigned to the first terminal.

13. The method of claim 11, wherein the uplink transmission information comprises information associated with an uplink radio resource, and
the receiving comprises receiving the data using the uplink radio resource.

14. The method of claim 11, wherein the uplink transmission information comprises information associated with a modulation scheme and a channel coding scheme with respect to the data, and the receiving comprises receiving the data according to the modulation scheme and the channel coding scheme.
